(19) United States
(12) Patent Application Publication
(10) Pub. No.: US 2025/0020948 A1
(43) Pub. Date: Jan. 16, 2025

(54) SPATIAL LIGHT MODULATION UNIT AND SPATIAL LIGHT MODULATION DEVICE

(71) Applicants: Tsinghua University, Beijing (CN); HON HAI PRECISION INDUSTRY CO., LTD., New Taipei (TW)

(72) Inventors: LI-WEN LAI, Beijing (CN); PENG LIU, Beijing (CN); CHUN-HAI ZHANG, Beijing (CN); DUAN-LIANG ZHOU, Beijing (CN); QUN-QING LI, Beijing (CN); SHOU-SHAN FAN, Beijing (CN)

(21) Appl. No.: 18/769,466

(22) Filed: Jul. 11, 2024

(30) Foreign Application Priority Data
Jul. 12, 2023 (CN) 202310854692.5

(51) Int. Cl. G02F 1/00; B82Y 20/00; B82Y 30/00; G02F 1/01; G02F 1/169

(52) U.S. Cl. CPC G02F 1/0054; B82Y 20/00; B82Y 30/00; G02F 1/0063; G02F 1/009; G02F 1/0102; G02F 1/169; G02F 2202/36

(57) ABSTRACT

A spatial light modulation unit includes a first electrode, a second electrode and a super-aligned carbon nanotube-paraffin composite structure. The first electrode is spaced apart and insulated from the first electrode. The super-aligned carbon nanotube-paraffin composite structure is electrically connected to the first electrode and the second electrode. The super-aligned carbon nanotube-paraffin composite structure includes a super-aligned carbon nanotube structure and a paraffin layer overlapped with each other.

### CROSS-REFERENCE TO RELATED APPLICATIONS

This application claims all benefits accruing under 35 U.S.C. § 119 from China Patent Application No. 202310854692.5, filed on Jul. 12,2023, in the China National Intellectual Property Administration, the contents of which are hereby incorporated by reference.

### FIELD

The present disclosure relates to a spatial light modulation unit and a spatial light modulation device.

### BACKGROUND

Based on the ultra-small heat capacity per unit area (HCPUA) and fast thermal response properties of super aligned carbon nanotube (SACNT) films, SACNT films can be quickly electrically modulated heated and used as infrared light sources for NDIR greenhouse gas monitoring. SACNT films also have other outstanding properties such as ultra-thinness, conductivity, transparency, flexibility, stretchability, uniformity, high emissivity, and large-area preparation. Increased research activities have been made to utilize SACNT in the fields of optical and thermal managements.

However, the application of SACNT films in optical active control needs further development. A typical application is spatial light modulation, which can be realized based on photonic crystals, liquid crystals, surface plasmas and phase change materials. Due to the advantages of fast thermal response, ultra-small HCPUA, easy large-area preparation and cutting, SACNT films have successfully realized functions such as fast controllable incandescent light source arrays, fast thermal actuators, and fast adaptive thermal camouflage. There is little research in applying SACNT films in the field of spatial light modulation.

### BRIEF DESCRIPTION OF THE DRAWINGS

Implementations of the present technology will now be described, by way of example only, with reference to the attached figures, wherein:

FIG. 1 is a schematic diagram of the structure of a spatial light modulation device provided by an embodiment according to the present disclosure.

FIG. 2 is a schematic diagram of the structure of a super-aligned carbon nanotube film-paraffin composite structure in an embodiment according to the present disclosure.

FIG. 3 is a scanning electron microscope photo of a single-layer super-aligned carbon nanotube film in an embodiment according to the present disclosure.

FIG. 4 is comparative photo of transparency of the super-aligned carbon nanotube-paraffin composite structure between before and after a paraffin layer in the super-aligned carbon nanotube-paraffin composite structure melts.

FIG. 5 is a light transmittance spectrum of super-aligned carbon nanotube-paraffin composite structures with different surface densities of paraffin wax when the paraffin layer is in a solidified state.

FIG. 6 is a transmittance of the super-aligned carbon nanotube-paraffin composite structure when the surface density of the paraffin layer is 2.81×10⁻⁴ g/mm² and the power is repeatedly turned on and off.

FIG. 7 is the transmittance difference between power on and power off of the super-aligned carbon nanotube-paraffin composite structure when the surface density of the paraffin layer is 2.81×10⁻⁴ g/mm².

FIG. 8 is a comparison between modulated pulse signals and transmission signals obtained by the silicon (Si) detector (operating wavelength region: 350 nm-1100 nm) during modulated heating.

FIG. 9 is a photo taken from a back of the spatial light modulation device showing the word “THU” modulated by an addressable circuit.

### DETAILED DESCRIPTION

The disclosure is illustrated by way of example and not by way of limitation in the figures of the accompanying drawings in which like references indicate similar elements. It should be noted that references to “another,” “an,” or “one” embodiment in this disclosure are not necessarily to the same embodiment, and such references mean “at least one.”

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale, and the proportions of certain parts have been exaggerated to illustrate details and features of the present disclosure better.

Several definitions that apply throughout this disclosure will now be presented.

The term “substantially” is defined to be essentially conforming to the particular dimension, shape, or other feature which is described, such that the component need not be exactly or strictly conforming to such a feature. The term “comprise,” when utilized, means “include, but not necessarily limited to”; it specifically indicates open-ended inclusion or membership in the so-described combination, group, series, and the like. The term of “first”, “second” and the like, are only used for description purposes, and should not be understood as indicating or implying their relative importance or implying the number of indicated technical features. Thus, the features defined as “first”, “second” and the like expressly or implicitly include at least one of the features. The term of “multiple times” means at least two times, such as two times, three times, etc., unless otherwise expressly and specifically defined.

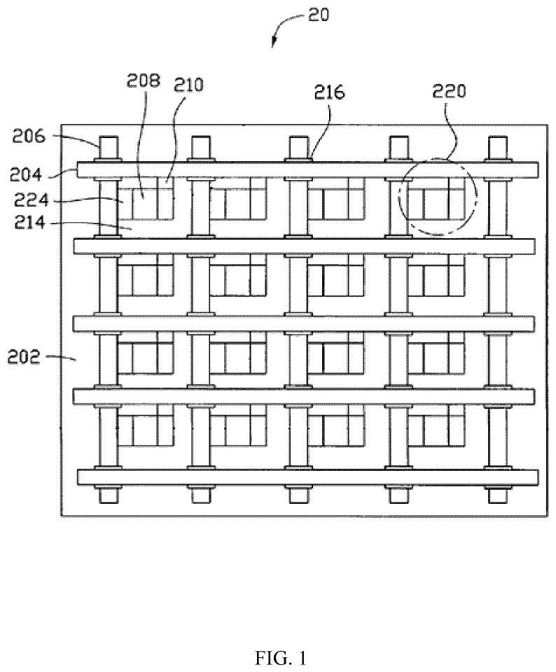

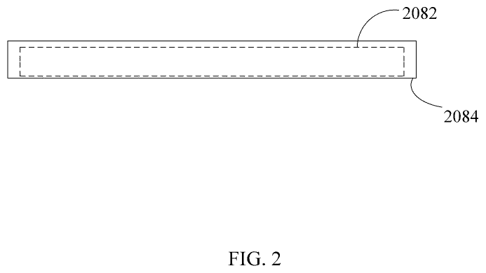

Referring to FIG. 1 and FIG. 2, the present invention provides a spatial light modulation device 20. The spatial light modulation device 20 comprises an insulating substrate 202, a plurality of row electrodes 204, a plurality of column electrodes 206, and a plurality of spatial light modulation units 220. The plurality of row electrodes 204 and the plurality of column electrodes 206 are cross-arranged on the insulating substrate 202. The plurality of row electrodes 204 or the plurality of column electrodes 206 are separated by an insulating medium 216. Every two adjacent row electrodes 204 and two adjacent column electrodes 206 form a grid 214. Each grid 214 positions a spatial light modulation unit 220, that is, the spatial light modulation unit 220 corresponds to the grid 214 one by one.

The insulating substrate 202 is an insulating transparent substrate or a substrate with the highest possible transmittance in the visible light platinum band. A material of the insulating substrate 202 can be glass, resin quartz or flexible PI. A size and a thickness of the insulating substrate 202 are not limited, and can be set according to actual needs, such as according to the predetermined size of the heating device 20. In one embodiment, the insulating substrate 202 is preferably a square soda-lime glass substrate with a thickness of about 0.33 mm and a side length of about 80 mm.

The plurality of row electrodes 204 and the plurality of column electrodes 206 are arranged crosswise with each other. The dielectric insulating layer 216 is arranged at the intersection of the row electrode 204 and the column electrode 206, which can ensure electrical insulation between the row electrode 204 and the column electrode 206 to prevent short circuit. The plurality of row electrodes 204 or the plurality of column electrodes 206 can be arranged at equal intervals or at unequal intervals. Preferably, the plurality of row electrodes 204 or column electrodes 206 are arranged at equal intervals. The row electrodes 204 and the column electrodes 206 are conductive materials or insulating materials coated with a conductive material layer. In this embodiment, the plurality of row electrodes 204 and the plurality of column electrodes 206 are preferably planar conductors printed with conductive silver paste, and a row spacing of the plurality of row electrodes 204 is 3 mm, and a column spacing of the plurality of column electrodes 206 is 3 mm. Since a precision of the super-aligned carbon nanotube film cut by laser is tens of microns or even smaller, the spacing can be completely determined by the processing precision of screen printing and super-aligned carbon nanotube film. A width of the row electrode 204 or the column electrode 206 is 200 microns to 1000 microns, and the thickness of the row electrode 204 or the column electrode 206 is 30 microns to 100 microns. A crossing angle between the row electrode 204 and the column electrode 206 is in a range from 10 degrees to 90 degrees. In one embodiment, the row electrode 204 and the column electrode 206 can be prepared by printing the conductive paste on the insulating substrate 202 by screen printing, and the angle between them is about 90 degrees. Components of the conductive paste include metal powder, low melting point glass powder and binder. Among them, the metal powder is preferably silver powder, the binder is preferably pine alcohol or ethyl cellulose, and the specific physical properties of the metal powder and the binder can be adjusted according to actual needs.

The plurality of spatial light modulation units 220 are respectively arranged in the above-mentioned multiple grids 214 in a one-to-one correspondence. It can be understood that the plurality of spatial light modulation units 220 are arranged in a determinant to form a heating point array. Each spatial light modulation unit 220 corresponds to an independent heating point. Each spatial light modulation unit 220 includes a first electrode 210, a second electrode 224, and a super-aligned carbon nanotube-paraffin composite structure 208. The first electrode 210 corresponds to the second electrode 224 and is arranged at an insulating interval. A distance between the first electrode 210 and the second electrode 224 in each grid 214 is the same as a thickness of the insulating dielectric layer 216. The super-aligned carbon nanotube film composite structure 208 is arranged between the first electrode 210 and the second electrode 224, and is electrically connected to the first electrode 210 and the second electrode 224, respectively. A preparation process of screen printing spatial light modulation array is:
1) Printing a column electrode layer;
2) Printing an insulating dielectric layer;
3) Printing a row electrode layer;
4) Printing first electrode and second electrode layer, both of which can be made on a printing screen;
5) Laying a single layer of super-aligned carbon nanotube film with a width greater than the width of the entire printed array on the entire printed array;
6) Using a laser cutting machine to cut the super-aligned carbon nanotube film through a specified ablation program, only a part where the first electrode and the second electrode are in contact is left, and only a part inside the grid is left in the entire spatial light modulation unit;
7) The entire substrate after completing the above steps is placed on a hot plate with a temperature higher than the melting point of paraffin. The paraffin used in this embodiment is No. 58 paraffin, and its melting point is 58° C. Pour the melted paraffin on the four corners of the entire printed array, wait for the paraffin to be evenly spread on the array, turn off the power of the hot plate, and wait for the paraffin to solidify naturally, so as to form the final spatial light modulation array.

Based on the above steps, it can be known that in a grid 214, except for the electrode part, the insulating medium part and the super-aligned carbon nanotube-paraffin composite structure 208, other areas are also covered by paraffin. When a thickness of the paraffin is large enough to cover the electrode, the paraffin will also cover the electrode part. However, the working area is limited to the area at 208. In one embodiment, the first electrodes 210 in the spatial light modulation unit 220 of a same row are electrically connected to a same row electrode 204, and the second electrodes 224 in the spatial light modulation unit 220 of the same column are electrically connected to the same column electrode 206.

The second electrode 224 and the first electrode 224 are both conductors, such as metal layers. The first electrode 210 can be an extension of the row electrode 204, and the second electrode 224 is an extension of the column electrode 206. The first electrode 210 and the row electrode 204 can be integrally formed, and the second electrode 224 and the column electrode 206 can also be integrally formed. In this embodiment, the first electrode 210 and the second electrode 224 are both planar conductors, and their materials can be the same as the printed materials of the row electrode or the column electrode, as long as they are conductive electrodes. The first electrode 210 is directly electrically connected to the row electrode 204, and the second electrode 224 is directly electrically connected to the column electrode 206. A length of the first electrode 210 or the second electrode 224 is in a range from 100 microns to 1 mm, a width is in a range from 100 microns to 1 mm, and a thickness is in a range from 10 microns to 500 microns. In one embodiment, the material of the first electrode 210 and the second electrode 224 is conductive paste, which is printed on the insulating substrate 202 by screen printing. The composition of the conductive paste is the same as that of the conductive paste used for the above-mentioned electrodes.

Before laying the super-aligned carbon nanotube film, the heating unit 220 can print a bonding layer with the same shape as the first electrode and the second electrode, which is made of the bonding agent in the paste in the electrode 204, and is used to fix and adhere the super-aligned carbon nanotube film to ensure that the super-aligned carbon nanotube film is more firmly fixed on the first electrode 210 and the second electrode 224. It can be understood that the bonding layer is an optional structure, and the spatial light modulation unit 220 may not include a bonding layer. In addition, for convenience, the bonding layer can also be directly an electrode paste, as long as it does not affect the connection between the first electrode 210 or the second electrode 224 and the super-aligned carbon nanotube film. In one embodiment, the silver paste used for printing electrodes is used.

Referring to FIG. 2, the super-aligned carbon nanotube-paraffin composite structure 208 comprises a super-aligned carbon nanotube structure 2082 and a paraffin layer 2084. The paraffin layer 2084 is a thin layer of paraffin material. The paraffin layer 2084 is infiltrated on the super-aligned carbon nanotube structure 2082, and at least a portion of the paraffin layer 2084 penetrates into the micropores of the super-aligned carbon nanotube structure 2082. A thickness of the super-aligned carbon nanotube structure 2082 is in a range from 30 microns to 100 microns, and a thickness of the paraffin layer is in a range from 300 microns to 1 mm.

The super-aligned carbon nanotube structure is a self-supporting structure. The so-called “self-supporting structure” means that the super-aligned carbon nanotube structure can maintain its own specific shape without being supported by a support body. The super-aligned carbon nanotube structure of the self-supporting structure comprises a plurality of carbon nanotubes, and the plurality of carbon nanotubes attract each other through van der Waals forces, so that the carbon nanotube structure has a specific shape. The carbon nanotubes in the super-aligned carbon nanotube structure comprise one or more of single-walled carbon nanotubes, double-walled carbon nanotubes and multi-walled carbon nanotubes. A diameter of the single-walled carbon nanotube is in a range from 0.5 nanometers to 50 nanometers, a diameter of the double-walled carbon nanotube is in a range from 1.0 nanometers to 50 nanometers, and a diameter of the multi-walled carbon nanotube is in a range from 1.5 nanometers to 50 nanometers. There are a plurality of gaps between the carbon nanotubes in the super-aligned carbon nanotube structure, so that the super-aligned carbon nanotube structure has a large number of micropores. A heat capacity per unit area of the carbon nanotube structure is 7.7×10⁻³ joules per square meter Kelvin. Since the heat capacity of carbon nanotubes is small, the super-aligned carbon nanotube structure has a faster thermal response speed and can be used to quickly heat an object.

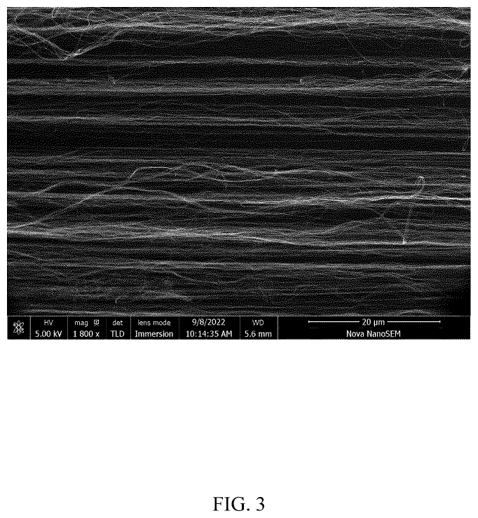

The super-aligned carbon nanotube structure includes at least one layer of super-aligned carbon nanotube film. Please refer to FIG. 3, specifically, the super-aligned carbon nanotube film comprises a plurality of continuous and directional carbon nanotube segments. The plurality of carbon nanotube segments are connected end to end by van der Waals forces. Each carbon nanotube segment comprises a plurality of parallel carbon nanotubes, and the plurality of parallel carbon nanotubes are tightly combined by van der Waals forces. The carbon nanotube segment has an arbitrary width, thickness, uniformity and shape. The carbon nanotubes in the super-aligned carbon nanotube film are preferentially oriented and arranged in a same direction. The super-aligned carbon nanotube film can be directly obtained by pulling a carbon nanotube array.

A method for preparing the spatial light modulation device 20 can comprises the following steps: printing row electrodes, insulating dielectric layers, column electrodes (longitudinal electrodes), first electrodes, second electrodes and bonding layer on the insulating substrate in that sequence; and, laying a single layer of super-aligned carbon nanotube films, laser cutting super-aligned carbon nanotube films and infiltrating the super-aligned carbon nanotube film array with melted paraffin.

The first electrode and the second electrode together constitute a CNT electrode, that is, an electrode for carrying a super-aligned carbon nanotube film. Since the row and column silver electrodes, the CNT electrodes and the adhesive layer are all printed from a same silver paste. In addition, considering that the entire array will be controlled by circuits later, the ends of the row and column silver electrodes are designed to be thick and long to facilitate connection with the control circuit. After printing, each layer needs to be cured. The row and column silver electrodes, the insulating dielectric layer, and the CNT electrode need to be sintered and cured at 570° C. The bonding layer used to adhere the super-aligned carbon nanotube film is only required to place the entire array on a hot plate with a surface temperature of 150° C. and heat it for 5 minutes after laying a single layer of super-aligned carbon nanotube film. Finally, the super-aligned carbon nanotube film is cut with a laser and the super-aligned carbon nanotube film between the CNT electrodes is retained to obtain a complete super-aligned carbon nanotube film array. Subsequently, the glass substrate and the culture dish containing paraffin are placed on a hot plate at a temperature of 100° C. When the paraffin is melted, drop the paraffin liquid on the four corners other than the cross mark on the edge of the super-aligned carbon nanotube film array. When it is evenly spread on the super-aligned carbon nanotube film array, a uniform composite structure of super-aligned carbon nanotube film and paraffin layer can be formed, that is, a super-aligned carbon nanotube-paraffin composite structure. Finally, turn off the power of the hot plate and wait for the paraffin to solidify naturally to obtain the final sample.

The spatial light modulation device provided by the present invention can realize periodic changes in light intensity. When used, by energizing the super-aligned carbon nanotube structure in the spatial light modulator, the super-aligned carbon nanotube structure generates Joule heat, causing the temperature to rise, thereby heating the paraffin layer covering the super-aligned carbon nanotube structure and melting the paraffin layer. After the paraffin layer melts, the transmittance of the super-aligned carbon nanotube-paraffin composite structure increases. Under the control of the circuit, as the super-aligned carbon nanotube film at the corresponding point of the array is heated, the paraffin melts, and the low light rate in the original solidified state is converted into high transmittance, thereby realizing effective spatial light modulation on the addressable array.

In the present invention, the super-aligned carbon nanotube-paraffin composite structure is made into an addressable array by screen printing technology, and the temperature of the corresponding pixel points on the super-aligned carbon nanotube film composite structure array is controlled by the circuit, so that the temperature of the paraffin layer composited with the super-aligned carbon nanotube structure in the super-aligned carbon nanotube-paraffin composite structure can also be quickly modulated. Due to the rapid thermal response of the super-aligned carbon nanotube structure, the temperature of the paraffin covering the super-aligned carbon nanotube structure also changes rapidly, resulting in rapid phase change modulation. Under the control of the circuit, as the super-aligned carbon nanotube structure at the corresponding point of the array is heated, the paraffin layer melts, converting the low transmittance in the original solidified state into high transmittance, achieving a significant difference in the transmitted light intensity, thereby achieving effective spatial light modulation on the addressable array.

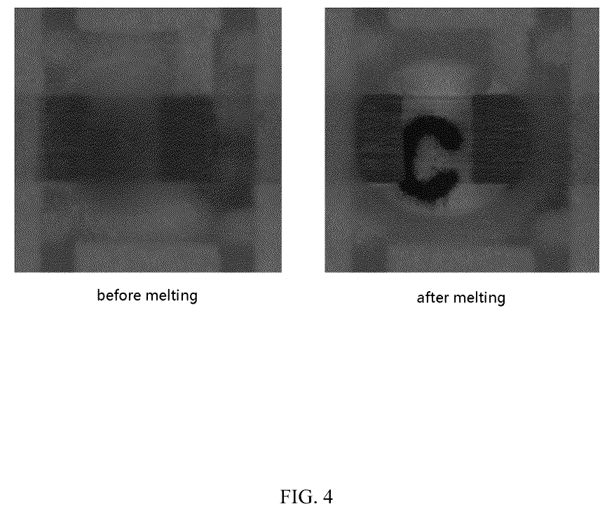

In this embodiment, the super-aligned carbon nanotube structure includes a layer of super-aligned carbon nanotube film. Please refer to FIG. 4, a piece of white paper with the letter “C” printed on it is pasted on the substrate on the back of the dot matrix, and the point is electrically heated. FIG. 4 shows the display comparison of the letter “C” before and after the paraffin on the dot matrix is melted. Before the paraffin layer melts, although the transmittance of the single-layer super-aligned carbon nanotube film and the glass substrate is high, the letters on the back of the glass substrate are almost invisible due to the presence of solidified paraffin. After the paraffin melts, not only the carbon nanotubes in the super-aligned carbon nanotube film become clear, but also the letter “C” behind the glass substrate is displayed, and the carbon powder around the inkjet-printed letters can be observed. This shows that the paraffin causes the heated dot matrix to have a large difference in optical transmittance before and after melting. This is because the refractive index decreases after the paraffin melts. The refractive index of liquid paraffin is about 1.43, while the refractive index of water is 1.33. Therefore, the refractive index of the melted paraffin is close to that of water. Therefore, the melting of the paraffin reduces the reflectivity of the composite structure and increases the transmittance.

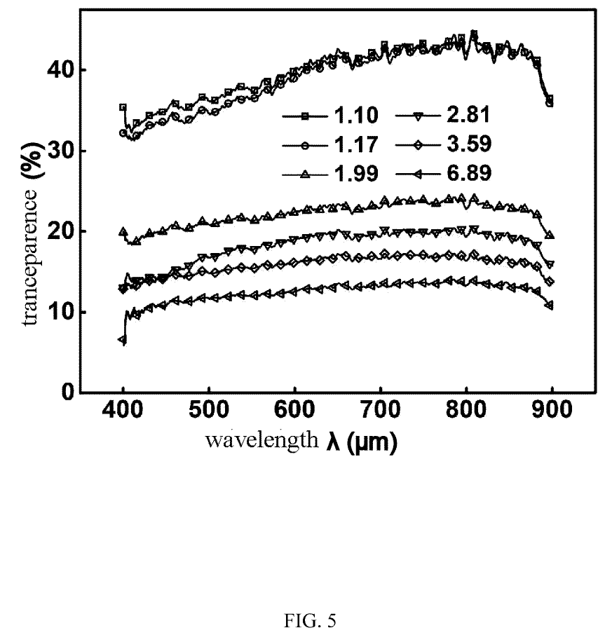

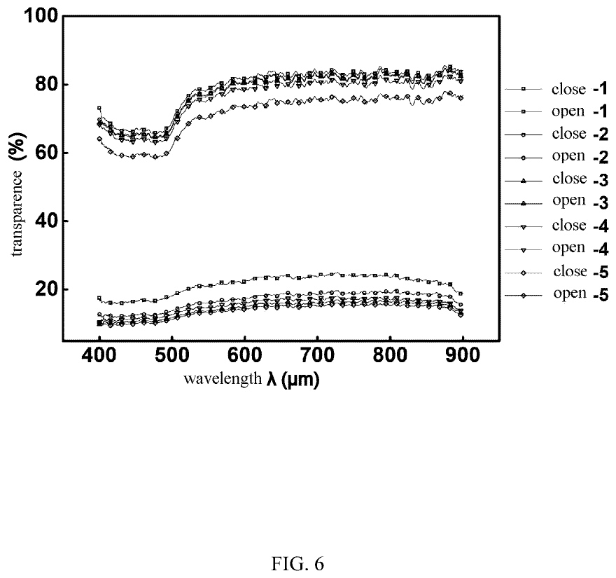

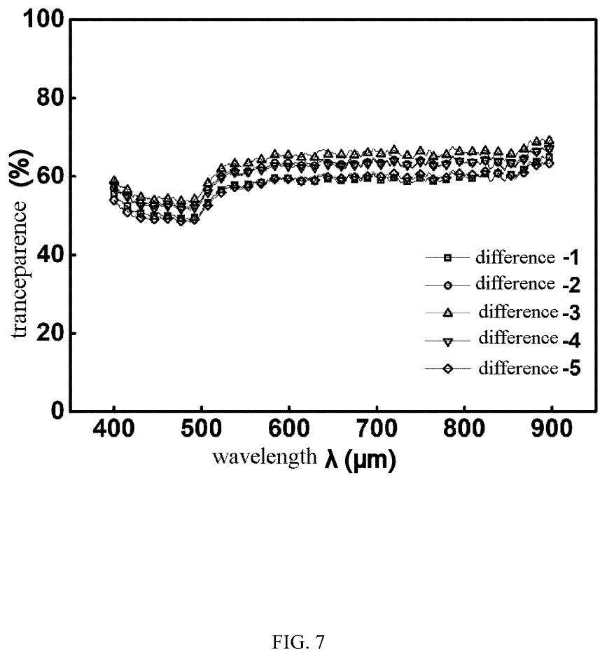

FIG. 5 also proves that after the paraffin layer melts, the transmittance of the super-aligned carbon nanotube-refractive paraffin composite structure increases significantly. The surface density in FIG. 5 refers to the mass surface density of the paraffin. In order to test the change of transmittance of super-aligned carbon nanotube-paraffin composite structure before and after the paraffin phase change, the transmittance of the composite structure after the paraffin was melted was tested, and the super-aligned carbon nanotube film on the array was repeatedly turned on and off. For the sample with a paraffin surface density of 2.81×10⁻⁴ g/mm², the transmittance was repeatedly tested, and the results are shown in FIG. 6. Furthermore, the difference in transmittance caused by the paraffin changing back and forth between the solidification and melting states due to the on and off of the power was calculated and given in FIG. 7. It can be seen that, for the composite structure array with a paraffin surface density of 2.81×10⁻⁴ g/mm², the difference in transmittance can reach more than 48%. It was calculated that in the 400 nm-900 nm region, the average value of the transmittance difference reached 57.57%, which would cause a large difference in the transmitted light intensity.

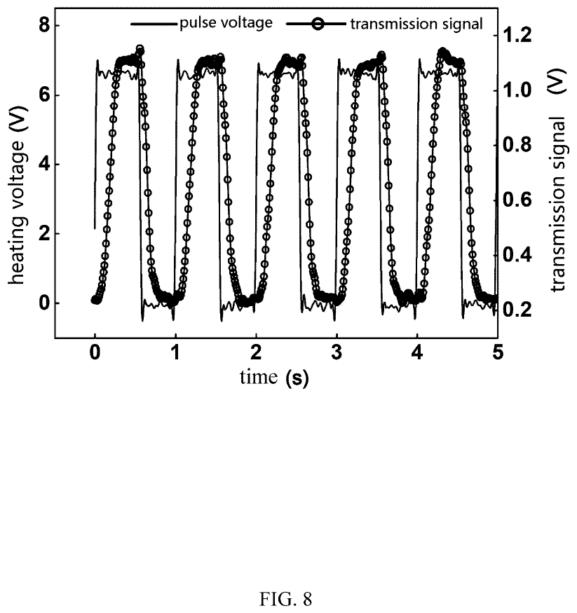

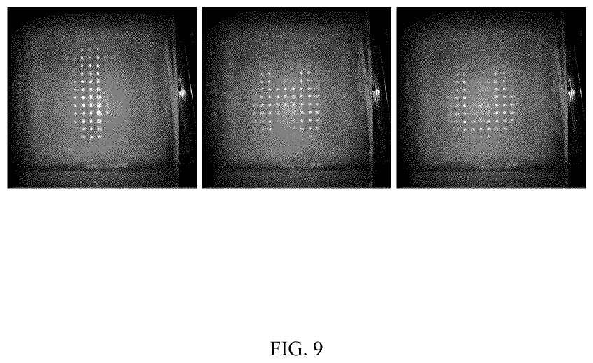

In another test experiment, a lamp was set up directly above the entire spatial light modulation device to illuminate the entire spatial light modulation device, and a piece of white paper was placed at a certain distance behind the spatial light modulation device to observe the light and shadow changes on the white paper after the super-aligned carbon nanotube-paraffin composite structure on the dot matrix in the array was periodically heated by the pulse voltage signal, and the light intensity changes after repeated power on and off were tested with a Si detector. The results are given in FIG. 8. Based on all the above results, a piece of frosted glass was placed on the back of the glass substrate, combined with the characteristics of the addressable array obtained by screen printing, and the control circuit was used to obtain the effect of spatial light modulation, which is a pattern of the three letters “THU”, as shown in FIG. 9. It can be seen that, the constructed array has achieved a very clear and distinct “THU” word.

Compared with the prior art, the spatial light modulation device provided by the present invention includes a super-aligned carbon nanotube-paraffin composite structure, and the super-aligned carbon nanotube-paraffin composite structure includes a carbon nanotube structure and a paraffin layer. Due to the rapid thermal response of the super-aligned carbon nanotube film, the temperature of the paraffin covering the super-aligned carbon nanotube structure also changes rapidly, thereby causing a rapid phase change. Under the control of the circuit, as the electrode heats the super-aligned carbon nanotube structure, the paraffin melts, converting the low light transmittance in the original solidified state into a high light transmittance, thereby realizing spatial light modulation. The present invention composites the super-aligned carbon nanotube film array with paraffin, and based on the rapid electrical modulation performance of the super-aligned carbon nanotube film, it can realize rapid phase change and spatial light modulation in a short time. In the present invention, the super-aligned carbon nanotube film is made into an addressable heater array by screen printing technology, and the super-aligned carbon nanotube film corresponding to the pixel points on the super-aligned carbon nanotube film array is modulated and heated by the circuit, so that the temperature of the paraffin covering the pixel points on the super-aligned carbon nanotube film can also be quickly modulated, and the spatial light modulation effect of the entire array can also be controlled.

It is to be understood that the above-described embodiments are intended to illustrate rather than limit the present disclosure. Variations may be made to the embodiments without departing from the spirit of the present disclosure as claimed. Elements associated with any of the above embodiments are envisioned to be associated with any other embodiments. The above-described embodiments illustrate the scope of the present disclosure but do not restrict the scope of the present disclosure.

Depending on the embodiment, certain of the steps of a method described may be removed, others may be added, and the sequence of steps may be altered. The description and the claims drawn to a method may include some indication in reference to certain steps. However, the indication used is only to be viewed for identification purposes and not as a suggestion as to an order for the steps.

What is claimed is:

1. A spatial light modulation unit comprising:
a first electrode;
a second electrode spaced apart and insulated from the first electrode; and
a super-aligned carbon nanotube-paraffin composite structure electrically connected to the first electrode and the second electrode, wherein the super-aligned carbon nanotube-paraffin composite structure comprises a super-aligned carbon nanotube structure and a paraffin layer overlapped with each other.

2. The spatial light modulation unit of claim 1, wherein the paraffin layer covers the super-aligned carbon nanotube structure and a part of the paraffin is infiltrated in the super-aligned carbon nanotube structure.

3. The spatial light modulation unit of claim 1, wherein a portion of the paraffin layer is infiltrated in the super-aligned carbon nanotube structure, and another portion is covered on the surface of the super-aligned carbon nanotube structure.

4. The spatial light modulation unit of claim 1, wherein the paraffin layer completely covers the super-aligned carbon nanotube structure.

5. The spatial light modulation unit of claim 1, wherein the super-aligned carbon nanotube structure comprises at least one super-aligned carbon nanotube film.

6. The spatial light modulation unit of claim 5, wherein the super-aligned carbon nanotube film comprises a plurality of continuous and directional carbon nanotube segments.

7. The spatial light modulation unit of claim 6, wherein the plurality of carbon nanotube segments are connected end to end by van der Waals forces.

8. The spatial light modulation unit of claim 1, wherein a thickness of the paraffinis in a range of 300 micrometers to 1 millimeter.

9. The spatial light modulation unit of claim 1, wherein a thickness of the super-aligned carbon nanotube structure is in a range of 30 micrometers to 100 micrometers.

10. A spatial light modulation device comprising:
an insulating substrate having a surface;
a plurality of row electrodes and a plurality of column electrodes arranged on the surface of the insulating substrate, the plurality of row electrodes and the plurality of column electrodes intersecting and insulated with each other, and each two adjacent row electrodes and each two adjacent column electrodes intersecting therewith to form a grid; and
and a plurality of light modulation units, each of the plurality of light modulation units corresponding to the grid, and each of the plurality of light modulation units comprising a first electrode, a second electrode and a super-aligned carbon nanotube-paraffin composite structure, the first electrode and the second electrode being electrically connected to the row electrode and the column electrode respectively, the heating element being electrically connected to the first electrode and the second electrode,
wherein the super-aligned carbon nanotube-paraffin composite structure comprises a carbon nanotube structure and a paraffin layer overlapped with each other.

11. The spatial light modulation device of claim 10, wherein the insulating substrate is electrically insulating and transparent.

12. The spatial light modulation device of claim 10, wherein the super-aligned carbon nanotube-paraffin composite structure is suspended above the insulating substrate by the first electrode and the second electrode.

13. The spatial light modulation device of claim 10, wherein the super-aligned carbon nanotube structure defines a plurality of gaps, a part of the paraffin layer penetrates the plurality of gaps of the super-aligned carbon nanotube structure, and another part covers the surface of the super-aligned carbon nanotube structure.

14. The spatial light modulation device of claim 13, wherein the paraffin layer completely covers the super-aligned carbon nanotube structure.

15. The spatial light modulation device of claim 10, wherein a thickness of the paraffinis in a range of 300 micrometers to 1 millimeter.

16. The spatial light modulation device of claim 10, wherein a thickness of the super-aligned carbon nanotube structure is in a range of 30 micrometers to 100 micrometers.
